(19) United States
(12) Patent Application Publication
(10) Pub. No.: US 2026/0233641 A1
(43) Pub. Date: Aug. 13, 2026

(54) Method and System for Controlling a Movement of a Movable Component in a Vehicle

(71) Applicant: Bayerische Motoren Werke Aktiengesellschaft, Muenchen (DE)

(72) Inventor: Stefan Schorer, Bad Woerishofen (DE)

(21) Appl. No.: 19/152,928

(22) PCT Filed: Oct. 11, 2023
(86) PCT No.: PCT/EP2023/078237

§ 371 Date: Jul. 31, 2025

(30) Foreign Application Priority Data
Feb. 24, 2023 (DE) 10 2023 104 521.0

(51) Int. Cl. B60N 2/02; B62D 1/18; G05B 17/02

(52) U.S. Cl. CPC B60N 2/0276; B62D 1/18; G05B 17/02

(57) ABSTRACT

A method for controlling a movement of at least one movable component in an interior of a vehicle includes obtaining first position data of a movable component and second position data of at least one other part of the vehicle interior. The first position data and second position data are obtained in a control unit such that the first position data and second position data are in a common coordinate system. The method also includes comparing the first position data and the second position data using a control unit to generate a comparison result. The method further includes controlling the movement of the movable component taking into account the comparison result, in such a way that a collision of the movable component and at least one other part of the vehicle interior is prevented.

The present application is the U.S. national phase of PCT Application PCT/EP2023/078237 filed on Oct. 11, 2023, which claims priority of German patent application No. 10 2023 104 521.0 filed on Feb. 24, 2023, the entire contents of which are incorporated herein by reference.

### TECHNICAL FIELD

The present disclosure relates generally to vehicles, and more particularly, to controlling a movement of a movable component in a vehicle.

### BACKGROUND

Vehicles have a number of movable components in their interiors, such as the seats, especially the driver's seat and front passenger seat, but also seats in the second row of seats. The seats are usually adjustable, i.e. movable, in their longitudinal position and height and the inclination of the seat backrest can also be adjusted. Other movable components, such as foldable monitors, may also be provided in the vehicle interior. As the number of movable components increases, the probability increases that they will overlap in their adjustment ranges, i.e. that if a component moves, there is a risk of a collision with another part of the vehicle interior. For example, folding down the second row of seats to the front can only be fully implemented if the seats in the first row are not too far back.

In the case of manually movable or adjustable seats, a possible collision must be detected by a user and, if necessary, the seats in the first row must first be moved forward before the rear bench can be folded down. In the case of electrically adjustable seats, the user is expected to automatically take this into account when controlling the movements and sequences, so that the components are adjusted as expected without collision.

Sequences for controlling movements are therefore often predefined and, for example, reduced to fixed sequences of individual steps. This, however, can lead to interruptions of movements if preconditions for a certain sequence of movements have not been observed, for example the position of another part that overlaps with the adjustment range. In addition, the formation of the step can take a long time. To protect against collisions, the logical monitor functions are connected via technical signals, for example the position value or semaphore status for areas is checked.

Typically, such networking of the components takes place close to the actuator in 1:1 relationships and must be adapted in the event of technical changes in the vehicle. The networking of several components in the vehicle interior is problematic due to different logic systems or technical measuring systems via a central location. However, the decentralized design of logic methods in the networking of groups is susceptible to intermediate states. This can be done, for example, in the case of the seat adjustment. In addition, such solutions are hardly expandable, so that extensive adjustments to the control system are necessary for a large number of vehicle variants or changes in the configuration.

There is a need, therefore, for improving the control of a movable component in a vehicle in order to achieve, for example, improved collision monitoring.

### SUMMARY

At least some embodiments described herein address the above-state need, as well as others.

A first aspect relates to a method, for example, computer-implemented method, for controlling the movement of at least one movable component in an interior space of a vehicle. Position data of the movable component and at least one other part of the vehicle interior are captured, wherein the position data are captured in a control unit in such a way that the data are in a common coordinate system. Controlling the movement involves comparing the position data of the movable component and of the at least one other part of the vehicle interior by the control unit, and the movement is controlled taking into account a result of the comparison in such a way that a collision of the movable component and at least one other part of the vehicle interior is prevented.

The above-mentioned method according to the first aspect is therefore based in particular on the fact that all position data are present in a common coordinate system, i.e. in particular in the same format, and that the monitoring or checking for a collision of the movable component during movement is carried out by a central control unit. In this way, the movement can take place without collisions. Instead of a 1:1 relationship between components in the vehicle interior, each with a special format and a “close-to-the-actuator” view, collision monitoring takes place in a central logic. Here observation of a large number of technical variants of a vehicle can be carried out with the same monitoring logic, which engages by regulating the sequence of movements or the position of the movable component.

Central monitoring can be used for all movable components, the position data of which are therefore all available in the common coordinate system. The control of the movement, for example a seat adjustment, has a harmonious effect on a user and can be done in minimal time, as there are no unexpected delays or interruptions.

In particular, the coordinate system can be CAD coordinates of the vehicle, so that in principle there is comparability between vehicles. CAD coordinates allow a unique identification of a point in the vehicle, wherein the coordinates [x, y, z]=[0, 0, 0] can be in the middle of the front axle, for example.

The term “vehicle” used here refers in particular to a passenger r car, including all types of motor vehicles, hybrid-powered and battery-powered electric vehicles, as well as vehicles such as vans, buses, trucks, delivery vehicles and the like.

The term “movable component” in a vehicle interior, as used herein, is understood in particular to mean a component of a vehicle which is installed in the vehicle interior and can be moved or adjusted. In particular, the movement is not manual but is effected by actuators, (electric) motors, mechatronic adjusters, and the like. These include, for example, electrically adjustable seats of a vehicle, but also other adjustable or foldable objects in the vehicle interior, such as displays, shelves, tables, etc. or even the steering wheel (adjustment of the steering column in length and angle).

The term “position data” as used herein is understood in particular to be data that describe the situation, i.e. in particular the position and/or orientation, of the movable component in space. This is in particular the three-dimensional spatial region that includes the vehicle interior. In the case of movable components that are not laterally movable in the vehicle (i.e. in the y-direction or “to the left and right”), such as vehicle seats, it may be sufficient to consider only two coordinates. Using the example of the vehicle seats, it may be sufficient to move only o in the longitudinal direction (i.e. in the X direction or “forward and backward”) and vertical direction (i.e. in the Z direction or “up and down”) for monitoring collisions with other parts of the vehicle interior.

The terms “includes”, “contains”, “has”, “with”, or any other variant thereof as used herein are intended to cover non-exclusive inclusion. For example, a method or apparatus which includes or has a list of elements is not necessarily limited to those elements, but may contain other elements which are not expressly listed, or which are inherent in such a process or device.

Further, unless expressly stated otherwise, “or” refers to an inclusive or and not an exclusive “or”. For example, a condition A or B is satisfied by one of the following conditions: A is true (or present) and B is false (or not present), A is false (or not present), and B is true (or present), and both A and B are true (or present).

The terms “a” or “an” as used herein are defined in the sense of “one or more”. The terms “another” and “a further” and any other variant of them are to be understood in the sense of “at least one other”.

The term “plurality”, as used here, is to be understood as meaning “two or more”.

The term “configured” or “set up” to perform a particular function (and respective variations thereof) is to be understood as meaning that the corresponding device already exists in a design or setting in which the corresponding device can perform the function or at least it can be set—i.e. configured—in such a way that it can perform the function after the appropriate setting. The configuration can be done, for example, by suitably setting the parameters of a process sequence or switches or the like to activate or deactivate functionalities or settings. In particular, the device may have several predetermined configurations or operating modes, so that the configuration can be carried out by selecting one of these configurations or operating modes.

In the following, preferred embodiments of the method are described, each of which, unless it is expressly excluded or is technically impossible, can be combined with each other as well as with the other described aspects of the disclsoure.

With some embodiments, capturing the position data includes the conversion of control data of a control unit that controls a drive of the movable component into the common coordinate system. This can be done in particular when the control unit is activated, for example when a user selects the appropriate function in the vehicle, such as seat adjustment. The conversion can be carried out in particular into CAD coordinates.

With some embodiments, the comparison of the position data of the movable component and the at least one other part of the vehicle interior is carried out on the basis of defined distance rules. In other words, for the collision monitoring, in particular not only an actual overlap of the position data is taken into account, but for example falling below a minimum distance. This can be advantageous for an actual collision avoidance, as the control system does not only intervene when the movable component and the part of the vehicle interior actually collide, but when they are already too close to each other.

With some embodiments, the position data include at least one tracking point of the movable component defined in the common coordinate system, wherein the comparison is made on the basis of the at least one tracking point and/or an area around the tracking point. Instead of mapping the entire geometry of the movable component, it can be advantageous to use only one (or, as the case may be, more than one) tracking point. In particular, this can be a point that is relevant for the collision with the at least one other part of the vehicle interior. For example, for a driver's seat, the headrest position is characteristic of the adjusted position of the seat. A tracking point for a front seat can therefore be located, for example, in or on the headrest. It can also be advantageous to use an area assigned to the tracking point, which extends around the tracking point. In this way, a collision can be reliably prevented, similar to a distance rule.

With some of the associated embodiments, at least one tracking point is calculated using a geometric formula that takes into account control data of the control unit of the movable component. This can be transmitted into the system as a cyclical status.

With some embodiments, the movable component contains several subcomponents, wherein the control of the movement of the movable component involves controlling the of the subcomponents in a determined depending on the result of the comparison. In this way, a further improved movement of the movable component can be achieved, especially in comparison to a rigid sequence of the movements of the subcomponents (this includes partial movements and also degrees of freedom of a movement). Different phases of the movement can be flexibly controlled in order to finally bring the movable component from a starting position to a desired end position, which can be called up as a stored seating position if appropriate. For example, in the case of a seat adjustment with which the seat is not only moved in the longitudinal direction, but the inclination of the backrest must also be adjusted, the partial movements can be controlled depending on the environment. This can also be predefined in rules. A temporal overlap of the partial movements is also possible here. For example, in the case of a vehicle seat, first the longitudinal adjustment of the seat and, at least in part, the seat height adjustment can be carried out at the same time, followed by the adjustment of the backrest angle and the adjustment of the seat inclination, which can also be carried out at least partly at the same time. Finally, the headrests and the lumbar supports can be adjusted afterwards or at least partially at the same time.

With some embodiments, the at least one other part of the vehicle interior includes another movable component of the vehicle interior, wherein the control of the movement of the movable component involves controlling the movement of the other movable component. In situations where a collision of the movable component with another movable component is imminent, it may be necessary to move the other movable component to clear the way for the movement. Since the movement is controlled in the common coordinate system, collision monitoring and prevention for several movable components is possible in a simple way. A simple set of rules may be provided, which determine which movable components have priority under which conditions.

With some embodiments, the movable component includes at least one of a vehicle seat (in particular the front seat, rear seat), a display device and a steering wheel of the vehicle. With some embodiments, the other part includes at least one from a vehicle seat (especially front seat, rear seat), a display device and a steering wheel of the vehicle or even a fixed part of the vehicle interior. These components can all be designed to be movable and some of the movable components can overlap in their adjustment ranges, wherein a collision can then also be avoided as described above. Also, a fixed part of the vehicle interior, such as the headliner, the dashboard, and the like, can be in the way if the adjustment range is poorly chosen.

A second aspect relates to a data processing system comprising at least one processor configured to carry out the method as claimed in the first aspect.

Some embodiments of the system also include a central control unit which is set up to process the position data in order to monitor the movement of at least one movable component for a collision with at least one other part of the vehicle interior.

A third aspect relates to a computer program with instructions which, when implemented on system according to the second aspect, cause that system to carry out the method according to the first aspect.

In particular, the computer program may be stored on a non-volatile data carrier. Preferably, this is a data carrier in the form of an optical data carrier or a flash memory module. This can be advantageous if the computer program as such must be handled independently of a processor platform on which the one or more programs are to be executed. In another implementation, the computer program may exist as a file on a data processing unit, in particular on a server, and may be downloaded via a data connection, such as the Internet or a dedicated data connection, such as a proprietary or local network. In addition, the computer program can have a plurality of interacting individual program modules.

The system according to the second aspect can accordingly have a program memory in which the computer program is stored. Alternatively, the system can also be set up to access an external computer program available, for example, on one or more servers or other data processing units, via a communication connection, in particular in order to exchange data with it which are used during the course of the method or computer program or which constitute outputs of the computer program.

The features and advantages explained in relation to the first aspect also apply accordingly to the other aspects.

Further advantages, features, and applications of the present disclosure are given in the following detailed description in connection with the drawings.

### BRIEF DESCRIPTION OF THE DRAWINGS

FIG. 1 shows a view of a vehicle interior in a first configuration;

FIG. 2 shows a view of a vehicle interior in a second configuration;

FIG. 3 shows a side view of a vehicle seat; and

FIG. 4 shows a diagram of different sitting positions during a seat adjustment.

### DETAILED DESCRIPTION

In the figures, the same reference signs are consistently used for the same or corresponding elements.

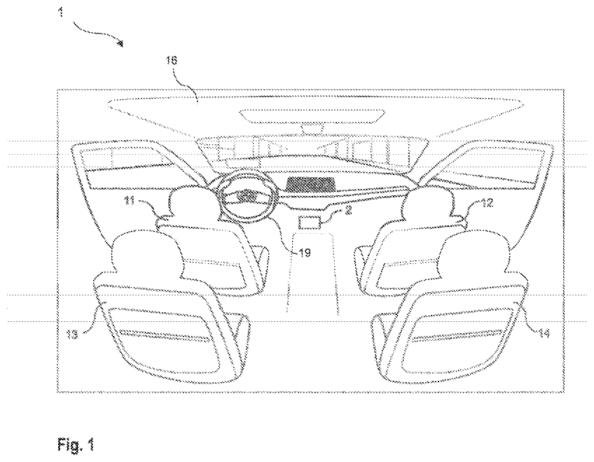

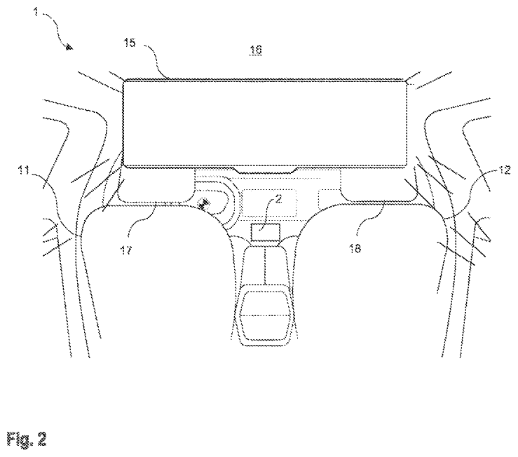

In FIG. 1 and FIG. 2, different configurations of a vehicle interior 1 are shown in a section from the rear. In vehicle interior 1 there are a number of movable, i.e. adjustable components, which can overlap in their adjustment ranges, SO that collision monitoring is required when controlling the movement. First and foremost, these are the seats of the vehicle with the driver's seat 11, passenger seat 12 and rear seats 13, 14. If the rear seats 13, 14 (or possibly a rear bench seat) are to be folded forward, this movement can only be fully performed, for example, if the front seats 11, 12 are not too far back. It may therefore be necessary to move one or both of the front seats 11, 12 forward a bit. The steering wheel 19 or steering column may also be adjustable, which can be taken into account with reference to the driver's seat 11.

FIG. 2 also shows a vehicle interior with a screen 15, which can be folded down from the roof liner 16 and can be used to entertain the rear passengers. In the folded down position, it is behind the front seats 11, 12, which would possibly bump into the screen 15 with their headrests 17, 18 if the seat were adjusted. Depending on the requirements of the application, it may therefore be necessary to fold up the screen 15 in order to be able to move one of the front seats further back, either by means of its longitudinal adjustment or backrest inclination. On the other hand, if a view of the screen 15 is desired, it may be preferable to move one or both of the front seats 11, 12 forward a bit.

A central control unit 2 is provided to monitor the movements of the movable components 11, 12, 13, 14, 15 for possible collisions. Drive positions of the movable components 11, 12, 13, 14, 15, i.e. for example positions of the respective actuators, are converted into position data in a common coordinate system, which can thus be easily compared with each other in the central control unit in order to avoid collisions with other parts of the vehicle interior when controlling the respective movements. These can be the other movable components or even fixed parts, such as the roof liner 16. In particular, the common coordinate system can be the CAD coordinate system of the vehicle, which is used by default in various vehicles and can have the same origin (for example center of the front axle, cf. FIG. 4) in order to allow portability and comparability even across vehicles.

The star-shaped design of the system can reduce the complexity and necessary computing power, especially compared to a network with 1:1 relationships of the respective adjacent components with each other. Changes and extensions are also easier to make. Using distance rules, which are cyclically checked in the central control unit 2, the movements can be controlled without collisions.

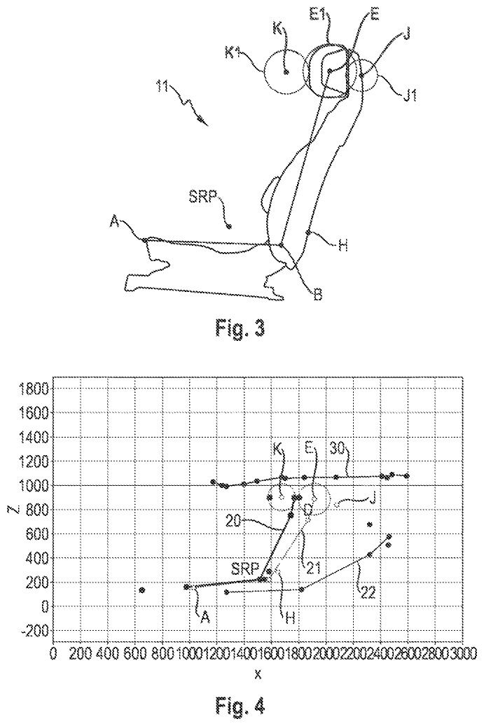

The position data of the movable components 11, 12, 13, 14, which are calculated from the drive positions as mentioned above, contain in particular individual tracking points of the movable components 11, 12, 13, 14. A side view of the driver's seat 11 is shown for this in FIG. 3 with the corresponding tracking points A, B, E, J and K. These points define characteristic points for the driver's seat 11, from which the position thereof can be derived, and are used for collision monitoring. Of course, fewer or more or different points can serve as tracking points.

In this exemplary embodiment, a tracking point A is located on the front edge of the seat, a tracking point B on the seat linkage, a tracking point H at the level of a passenger's hips, a tracking point E in the headrest, a tracking point J on the back of the seat at head height and finally a tracking point K, which does not mark a direct point of the seat but the position of a passenger's head. The tracking point K thus also prevents a collision of a passenger's head with other parts of the vehicle interior if they sit on the seat during seat adjustment. In order to avoid a collision, especially in the head area, corresponding distance ranges K1, E1, J1 are defined around the tracking points K, E, J. SRP refers to the seat reference point, a fixed spatial point that defines a standard sitting position.

It should be mentioned here that for other objects, such as the above-mentioned screen 15, which has only two positions (folded in the roof liner or folded down), it can be advantageous to define a fixed spatial point (not shown), for example in the area of the folded down screen 15, which is used for collision monitoring. The screen 15 can then be folded back during movement of the front seats 11, 12 should there be a risk of a collision of the seat with this point.

FIG. 4 schematically shows the adjustment of the driver's seat from an upright starting position 20 or a reclined position 21 to a lying position 22. The tracking points described with reference to FIG. 3 are also shown. The roofline 30 is also indicated. Depending on the type of vehicle and possible seat adjustment, an unfavorable seat adjustment can also lead to a collision, for example if a seat is moved too far up in a position that is too upright. The diagram from FIG. 4 shows the x and z components of the coordinates in the CAD coordinate system of the vehicle. A consideration of the y-component is not necessary here because none of the components can be moved laterally (i.e. in the y-direction), so that no collision check is necessary here.

The course of movement can be adjusted accordingly to avoid collisions and can also follow rules if appropriate. Here, in addition to the collision, other factors can also be taken into account, such as passenger comfort. It is desirable that a seat adjustment works harmoniously and does not take too long. Also, a passenger should not feel constricted by unfavorable, extreme seating positions during movement, for example. According to the sequence of movements in FIG. 4 first the backrest is adjusted backwards from the starting position 20 to the intermediate position 21, then further phases follow in which the backrest is tilted further, and the seat is lowered backwards, wherein the seat tilt is also reduced. During the course of the movement, the headrest is also extended slightly until the end position 22 is finally reached.

While at least one exemplary embodiment has been described above, it should be noted that there are a large number of variations of this. It should also be noted that the examples described are only non-limiting examples and are not intended to limit the scope, applicability or configuration of the devices and methods described herein. Rather, the preceding description will give the skilled person instructions for the implementation of at least one exemplary embodiment, wherein it is understood that various changes may be made in the operation and arrangement of the elements described in an exemplary embodiment without departing from the subject-matter defined in each of the attached claims and the legal equivalents thereof.

### REFERENCE SIGN LIST

1 Vehicle interior
2 Control unit
11 Driver's seat
12 Front passenger seat
13 Rear seat
14 Rear seat
15 Screen
16 Roof liner
17 Headrest
18 Headrest
19 Steering wheel
20 Starting position
21 Intermediate position
22 End position
30 Roofline

1.-12. (canceled)

13. A method for controlling a movement of at least one movable component in an interior of a vehicle, comprising:
obtaining first position data of a movable component and second position data of at least one other part of the vehicle interior, wherein the first position data and second position data are obtained in a control unit such that the first position data and second position data are in a common coordinate system,
comparing the first position data and the second position data using a control unit to generate a comparison result; and
controlling the movement of the movable component taking into account the comparison result, in such a way that a collision of the movable component and at least one other part of the vehicle interior is prevented.

14. The method as claimed in claim 13, wherein obtaining the position data includes converting control data of a control unit that controls a drive of the movable component into the common coordinate system.

15. The method as claimed in claim 14, the position data includes at least one tracking point of the movable component defined in the common coordinate system, wherein comparing the first position data and the second position data is carried out based at least in part on the at least one tracking point or an area around the tracking point.

16. The method as claimed in claim 15, wherein the at least one tracking point is calculated based at least in part on a geometric formula which takes into account the control data of the control unit of the movable component.

17. The method as claimed in claim 13, wherein comparing the first position data and the second position data is carried out based at least in part on defined distance rules.

18. The method as claimed in claim 13, the position data includes at least one tracking point of the movable component defined in the common coordinate system, wherein comparing the first position data and the second position data is carried out based at least in part on the at least one tracking point or an area around the tracking point.

19. The method as claimed in claim 18, wherein the at least one tracking point is calculated based at least in part on a geometric formula which takes into account control data of the control unit of the movable component.

20. The method as claimed in claim 13, wherein:
the movable component contains several subcomponents; controlling the movement of the movable component includes controlling movements of the subcomponents in a sequence that is determined depending on the comparison result.

21. The method as claimed in claim 20, wherein:
the at least one other part of the vehicle interior contains a further movable component of the vehicle interior; and
controlling the movement of the movable component involves controlling a movement of the further movable component.

22. The method as claimed in claim 13, wherein:
the at least one other part of the vehicle interior contains a further movable component of the vehicle interior; and
controlling the movement of the movable component involves controlling a movement of the further movable component.

23. The method as claimed in claim 13, wherein the movable component includes at least one from a group consisting of a vehicle seat, a display device and a steering wheel.

24. The method as claimed in claim 23, wherein the other part includes a fixed part of the vehicle interior.

25. The method as claimed in claim 13, wherein the other part includes at least one from a group consisting of a vehicle seat, a display device and a steering wheel of the vehicle.

26. The method as claimed in claim 13, wherein the other part includes a fixed part of the vehicle interior.

27. A system for data processing containing at least one processor configured to carry out the method as claimed in claim 13.

28. The system as claimed in claim 27, wherein the control unit is configured to process the position data in order to monitor the movement of the at least one movable component for a collision with the at least one other part of the vehicle interior.

29. A non-transitory computer readable medium having instructions which, when executed on computing device, carries out the method as claimed in claim 13.
